(19) United States
(12) Patent Application Publication
(10) Pub. No.: US 2006/0279429 A1
(43) Pub. Date: Dec. 14, 2006

(54) System using electronic device and commercial exhibition support method

(75) Inventor: Susumu Morioka, Saitama (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/551,551

(22) PCT Filed: Mar. 9, 2004
(86) PCT No.: PCT/JP04/03012

§ 371 Date: Sep. 30, 2005

(30) Foreign Application Priority Data
Mar. 31, 2003 (JP) 2003-094490

(51) Int. Cl. G11B 33/02; G08C 19/00

(52) U.S. Cl. 340/825.71; 720/600

(57) ABSTRACT

The present invention is relative to an electronic apparatus system including one or more electronic apparatus and an inputting device. A preset sequence of operations, pertaining to the mode of commercial demonstration, is carried out on the electronic apparatus (20), in response only to a preset command transmitted by the inputting device (10). Even if there are provided a plural number of the electronic apparatus (20) in the system, the operation for booting the mode of commercial demonstration for these plural electronic apparatus (20) may be carried out with the sole inputting device (10). This inputting device (10) is to be supplied only to an entity undertaking the commercial demonstration, such as a retail store. This disables the inputting device (10) to be used by the users at large so that the mode of commercial demonstration cannot be booted during use of the electronic apparatus by the users at large.

### TECHNICAL FIELD

This invention relates to an electronic apparatus system including one or more electronic apparatus, capable of performing the operations as the functions in support of in-store commercial display or demonstration, such as demonstrating operations, and to an inputting device for performing the operations pertinent to the support functions.

The present application contains subject matter related to Japanese Patent Application JP 2003-094490, filed in the Japanese Patent Office on Mar. 31, 2003, the entire contents of which being incorporated herein by reference.

### BACKGROUND ART

In certain types of the conventional electronic apparatus, such as AV (audio-visual) apparatus, there is preinstalled an in-store support mode for carrying out e.g. the commercial demonstration, pertinent to the functions of the apparatus, on the occasion of commercial demonstration in a retail store, such as in-store demonstration.

As an example of the in-store support mode, lamps mounted on an outer surface of the apparatus are turned on or off, by way of performing the function of demonstration. In an apparatus provided with a display unit, the operation of displaying e.g. the text for functional explanation is displayed thereon.

In particular, in certain types of the electronic apparatus, there is mounted an Eject-Lock mechanism for safeguarding a recording medium, mounted thereon, against theft. Specifically, there is annexed a function of annulling the operation of ejecting the recording medium mounted in the apparatus.

For booting the in-store support mode of this sort of the electronic apparatus, the following two systems are used:

The first system is such a system where a power supply cord of the electronic apparatus is plugged into a socket of a commercial power supply system, with the in-store support mode then being booted as the state of current conduction is detected by the apparatus.

The second system is such a one where the mode is booted following the current supply to the apparatus, responsive to specified actuation, such as multiple pressing, of the actuating key.

With the first system, the in-store support mode is booted subject only to plug-in of the power supply cord. Thus, in distinction from the second system, the first system does not entail complicated operations on the part of the retail store demonstrating the electronic apparatus, and hence increases the serviceability of the in-store support mode.

Meanwhile, the operation of the above-described in-store support mode is usually unneeded for users at large because these users may feel inconvenienced if the in-store support mode is booted each time the current is supplied to the apparatus.

On the other hand, for carrying out the functions proper to the electronic apparatus, the in-store support mode is desirably canceled. Moreover, for carrying out only the functions proper to the apparatus, the in-store support mode needs to be canceled. Hence, the user is compelled to cancel the in-store support mode, each time the current is supplied to the apparatus, in order to use the apparatus in the usual state of use, thus worsening the performance in the realization of the functions proper to the apparatus.

Moreover, the second system is onerous for the retail store side, because the retail store side has to learn the methods for specified operations for booting the in-store support mode, even granting that the problem on the side of the user may be resolved. In such case, the methods for the specified operations differ from one apparatus type to another, and hence the retail store side may be unable to grasp the operations for booting the in-store support mode for all of the types of the apparatus to be displayed. The result is that the in-store support functions, owned by the electronic apparatus, cannot be used efficaciously because the correct methods for booting these functions may remain unclear.

Hence, it is difficult with the conventional system for booting the in-store support mode to find optimum trade-off between the serviceability on the side of the retail store and that of the users at large.

For solving this problem, such a technique as disclosed in the Japanese Laid-Open Patent Publication JP2002-310483 has been proposed. This Laid-Open Patent Publication boots the mode for demonstration only when the preset conditions for the display state are detected. That is, with the technique disclosed in this Publication, an air conditioner is deemed to be not in the usual state of use only in case it is detected that the air conditioner is not connected to an outdoor unit, in which case the mode for demonstration then is booted at the same time as the current is supplied to the apparatus.

### DISCLOSURE OF THE INVENTION

It is an object of the present invention to provide a novel system employing an electronic apparatus and a novel method for supporting the commercial demonstration, whereby the problem inherent in the above-described conventional technique may be resolved.

It is another object of the present invention to provide a novel system employing an electronic apparatus, as an electronic apparatus system, whereby it is possible to find an optimum trade-off between the serviceability on the side of the retail store and that of the users at large, and a novel method for supporting the commercial demonstration.

For accomplishing the above objects, the present invention provides an electronic apparatus system comprising one or more electrical apparatus and an inputting device, in which the inputting device includes operation inputting means having one or more actuators, and command transmitting means for transmitting, responsive to actuation on the actuator(s) of the operation inputting means, a preset command code for causing the electronic apparatus to perform control operations for executing a preset operation relating to a mode of commercial demonstration. The electronic apparatus includes receiving means for receiving at least the command code, and control means for exercising control, responsive to the command code received by the receiving means, for carrying out the preset operation relating to the mode of commercial demonstration.

The present invention also provides a method for supporting commercial demonstration in an electronic apparatus system comprising one or more electrical apparatus and an inputting device. The inputting device is responsive to actuation on one or more actuators of operation inputting means to execute a command transmitting operational sequence for transmitting a preset command code for causing the electronic apparatus to carry out control processing for executing preset operations pertaining to the mode of commercial demonstration, whilst the electronic apparatus executes at least a receiving operational sequence of receiving the command code, and a control operational sequence of exercising control to allow execution of the preset operations pertaining to the mode of commercial demonstration, responsive to the command code received by the receiving operational sequence.

The present invention also provides an electronic apparatus in an electronic apparatus system comprising an inputting device and the electronic apparatus, in which the inputting device includes one or more actuators and transmits a preset command code responsive to actuation on the one or more actuators to cause the electronic apparatus to carry out control processing for executing preset operations pertaining to the mode of commercial demonstration. The electronic apparatus comprises receiving means for receiving at least the command code, and control means for exercising control to execute preset operations pertaining to the mode of commercial demonstration responsive to the command code received by the receiving means.

With the electronic apparatus, according to the present invention, the mode for commercial demonstration is booted subject only to receipt of a preset command transmitted from the inputting device. If the inputting device is to be donated only to, for example, the retail store, the use of this inputting device by the users at large is disabled, when it is attempted to boot the mode for commercial demonstration, such that the mode for commercial demonstration cannot be booted on the occasion of use of the electronic apparatus by the users at large.

If plural electronic apparatus, as in the case described above, are provided, the electronic apparatus according to the present invention, described above, boot the mode for commercial demonstration, responsive to preset commands transmitted from the inputting device, so that the booting operations for the mode for commercial demonstration for the plural electronic apparatus may be taken care of by the sole inputting device.

Other objects and specified advantages of the present invention will become more apparent from the following explanation of the embodiments especially when read in conjunction with the drawings.

### BRIEF DESCRIPTION OF THE DRAWINGS

FIG. 1 shows a schematic configuration of an in-store support system embodying the present invention.

FIG. 2 is a block diagram showing an inner structure of an electronic apparatus.

FIG. 3 is a block diagram showing an inner structure of an input device.

FIG. 4 is a plan view showing the appearance of the input device.

FIGS. 5A and 5B are plan views showing a display depicting the sequence of operations for booting an in-store support mode for an electronic apparatus system according to the present invention.

FIGS. 6A and 6B are similarly plan views showing a display configured for depicting a sequence of operations for booting an in-store support mode for an electronic apparatus system according to the present invention.

FIG. 7 is a flowchart showing a sequence of operations executed by an electronic apparatus system according to the present invention.

FIG. 8A shows the structure of a command signal, transmitted by a routine remote controller, and FIG. 8B shows the structure of a command signal, transmitted by a remote controller for in-store support.

### BEST MODE FOR CARRYING OUT THE INVENTION

An electronic apparatus system according to the present invention will now be explained, taking an example of applying the system to an in-store support system.

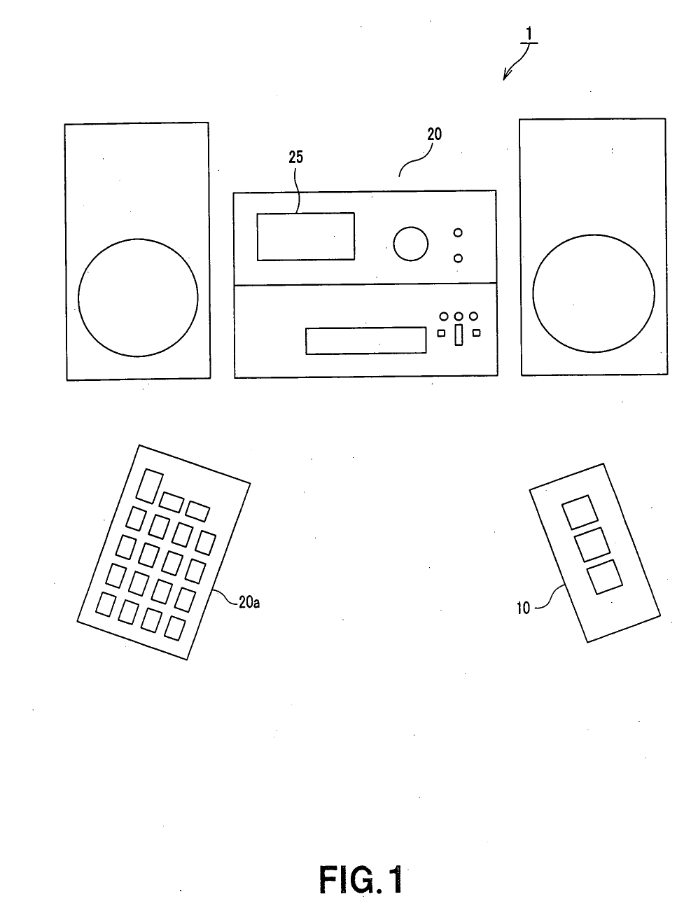

An in-store support system 1, according to the present invention, is made up at least by an electronic apparatus 20 and a remote controller for in-store support 10, as shown in FIG. 1.

The electronic apparatus 20, forming the in-store support system 1 according to the present invention, may be exemplified by an audio apparatus employing a CD (Compact Disc), an MD (Mini-Disc, as a magneto-optical disc) or a cassette tape, as a recording medium, and by a visual apparatus used for recording and/or reproducing information signals using a DVD (Digital Versatile Disc) or a video tape. The electronic apparatus 20 may comprise the visual and audio apparatus combined together to constitute a unitary AV (audio/visual) system apparatus.

The electronic apparatus 20, used in the in-store support system 1 of the present invention, is configured for setting an in-store support mode for carrying out demonstration pertinent to the functions owned by the apparatus at the time of commercial demonstration such as demonstration in a store. The operations carried out for this in-store support mode may be enumerated by, for example, demonstrating the text for functional explanation on a display 25 shown, as later explained, or on/off turning plural lamps, herein not shown, provided on an outer surface of the apparatus.

To the electronic apparatus 20, forming the in-store support system 1 of the present invention, a remote controller 20a, as an accessory unit of the electronic apparatus, as shown, is annexed, such that a user may enter operational commands to the electronic apparatus 20 through the remote controller 20a annexed thereto. The remote controller 20a, used as accessory unit of the electronic apparatus, usually makes use of infrared light. It is noted that the remote controller 20a, as accessory unit of the electronic apparatus, allows a user to perform only the operations in connection with usual functions of the electronic apparatus 20. That is, in-store support system 1 of the present invention is so designed and constructed that, with the remote controller 20a, as accessory unit of the electronic apparatus, the user is unable to perform the operations in connection with the in-store support mode described above.

The operation relating to the in-store support mode, in the electronic apparatus 20, is carried out by the remote controller for in-store support 10 shown. It is noted that the remote controller for in-store support 10 is provided only to the side undertaking the commercial demonstration of the electronic apparatus 20, such as a retail store, such that it is only the side undertaking the commercial demonstration that is allowed to execute operations relating to the in-store support mode of the electronic apparatus 20. By providing the remote controller for in-store support 10 only to the side of the retail store undertaking the commercial demonstration, the in-store support mode may not be booted during use of the electronic apparatus 20 by users at large.

Although the case in which the electronic apparatus 20 is the audio or visual apparatus has been explained in the above, the electronic apparatus, employed in the present invention, may be any other equipment which may be commercially demonstrated and which is provided with the in-store support function described above.

The ‘commercially demonstration’ as used in the explanation of the present invention is a generic name for demonstration on a public commercial site, such as on the site of exhibition or in a retail store.

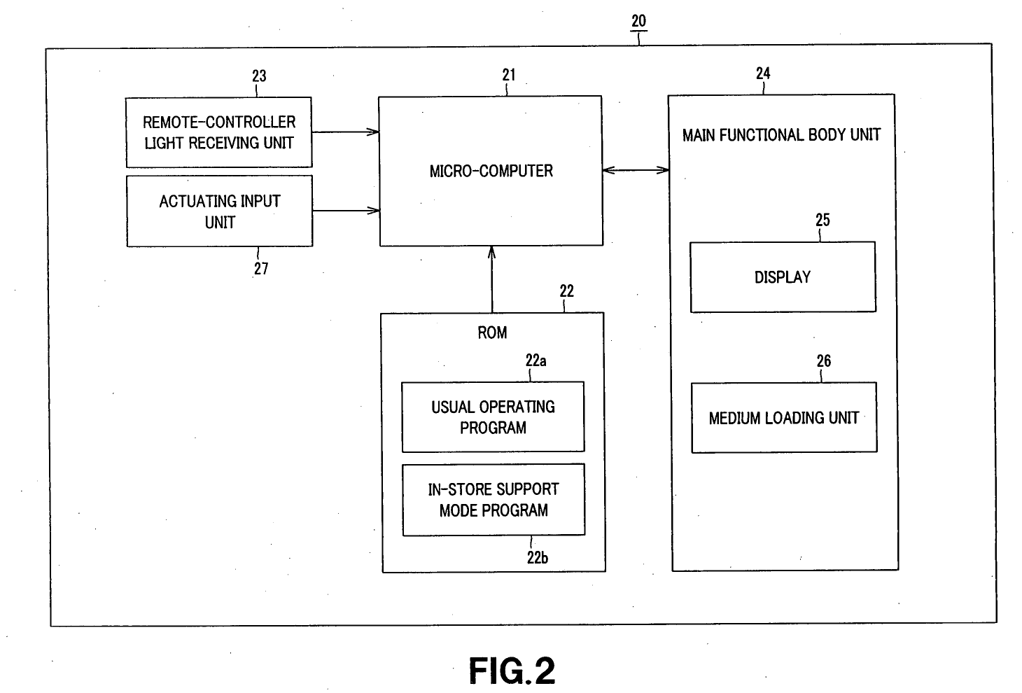

Referring to FIG. 2, the concrete structure of the electronic apparatus 20, forming the in-store support system 1, shown in FIG. 1, will now be explained.

The electronic apparatus 20 includes a main functional body unit 24, as shown in FIG. 2. This main functional body unit 24 carries out the operations innate to the electronic apparatus 20, which is an AV apparatus. That is, in case the electronic apparatus 20 is a recording and/or reproducing apparatus for a CD or a DVD, the main functional body unit 24 includes component elements, necessary for recording and/or reproducing information signals for a recording medium, such as, for example, an optical head, a spindle motor, a replay signal processor or a servo circuit.

The main functional body unit 24 is provided with a medium loading unit 26. On this medium loading unit 26 is loaded a recording medium for recording and/or reproducing information signals.

If the electronic apparatus 20 is constructed so as to be usable with plural mediums, such as optical discs, e.g. a CD or a DVD, or a cassette tape, a plural number of medium loading units 26 are respectively provided for different sorts of the mediums.

Moreover, the electronic apparatus 20, used for the system of the present invention, outputs a variety of the necessary information, such as replay time information, to the main functional body unit 24. The main functional body unit 24 includes a display 25 for demonstration of a variety of the necessary input information.

The main functional body unit 24 also includes an amplifier for amplifying the audio information, output from the electronic apparatus 20, and a loudspeaker for outputting the audio information as speech.

The electronic apparatus 20 also includes a remote-controller light receiving unit 23. This remote-controller light receiving unit 23 is configured for receiving an infrared light command signal, radiated from the remote controller 20a, annexed to the apparatus, shown in FIG. 1, and an infrared light command signal, radiated from the remote controller for in-store support 10, as later explained. The command signals, received by this remote-controller light receiving unit 23, are processed in a predetermined fashion, by this light receiving unit 23, and are output to a micro-computer 21 as operating input information or as data input information. The micro-computer 21 executes calculations or control as needed for the information entered from the remote-controller light receiving unit 23.

An actuating input unit 27 collectively represents inputting devices, such as various actuating keys, provided on an outer surface of the electronic apparatus 20. The user acts on this unit to enter a variety of actuating inputs and data. The actuating input unit 27 outputs actuating signals, corresponding to user actuations, to the micro-computer 21. This micro-computer 21 executes calculations and control, as needed, responsive to the input information. Similarly to the remote controller 20a, annexed to the apparatus, shown in FIG. 1, this actuating input unit 27 is able to fulfill only the usual functions innate to the electronic apparatus 20. That is, the electronic apparatus 20 is unable to perform the operations pertinent to the in-store support mode, described above, even with the actuating input unit 27.

The micro-computer 21, forming the electronic apparatus 20, executes the processing operations, in keeping with the booted program, to control the entire electronic apparatus 20, inclusive of the main functional body unit 24. To the micro-computer 21, a ROM 22 is connected, as shown in FIG. 2. This ROM 22 is a non-volatile memory and has stored therein a usual operating program 22a and an in-store support mode program 22b.

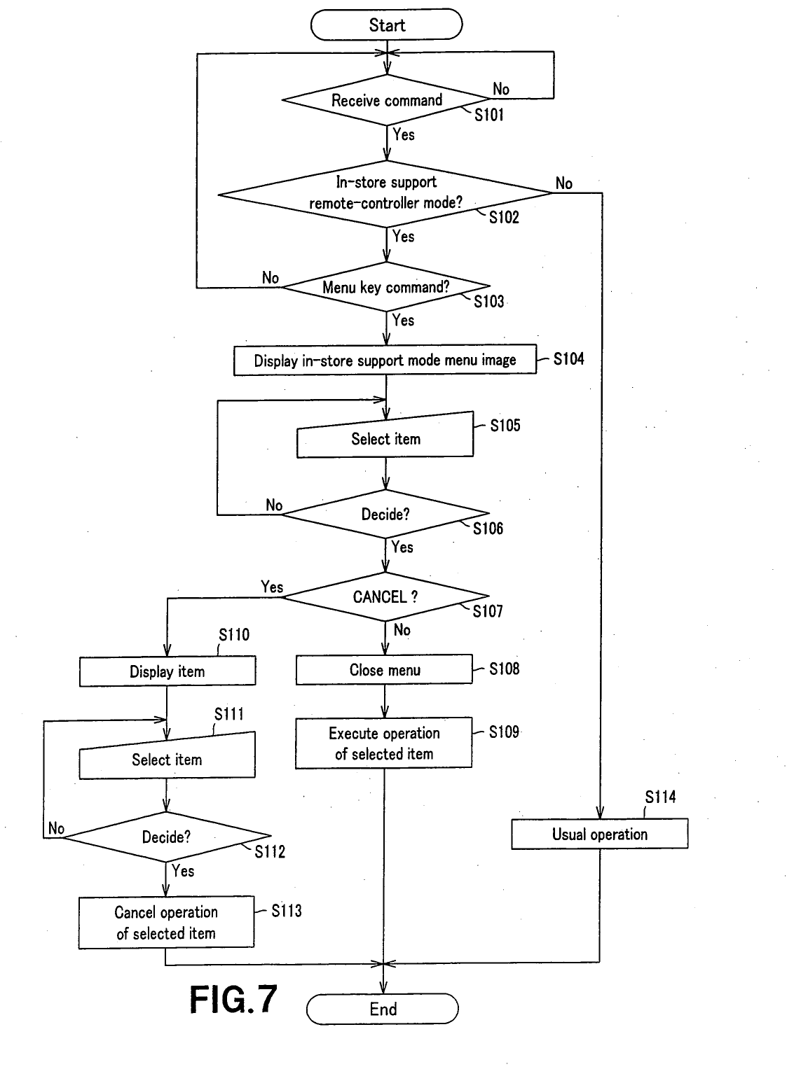

The in-store support mode program 22b, stored in the ROM 22, executes processing operations, shown in FIG. 7, as later explained, in order to execute the operations pertinent to the in-store support mode, explained with reference to FIG. 1. In contrast, the usual operating program 22a executes the usual functions, innate to the electronic apparatus 20, other than the in-store support mode. That is, when the electronic apparatus 20 is an AV apparatus, the usual operating program 22a executes the functions as the AV apparatus.

The ROM 22 includes a table for the micro-computer 21 to execute the operations in keeping with the command signals output from the remote controller 20a annexed to the apparatus, and from the remote controller for in-store support 10, shown in FIG. 1.

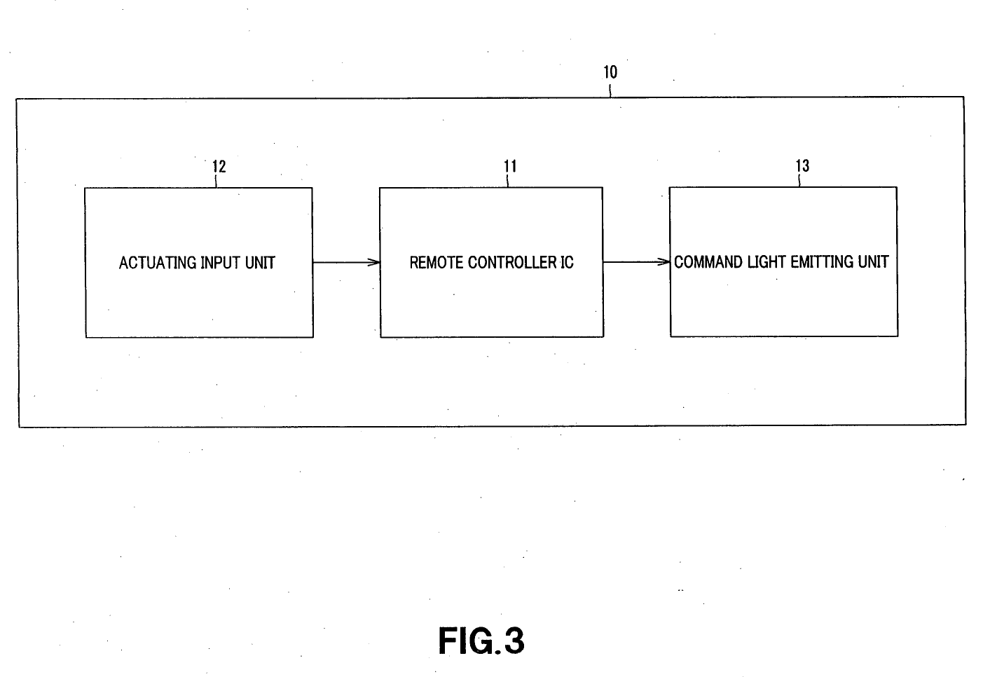

The remote controller for in-store support 10, shown in FIG. 1, includes an actuating input unit 12, as shown in FIG. 3. The actuating input unit 12 includes a variety of actuating keys facing the outer side of a casing of the main body unit of the remote controller. Examples of the actuating keys, forming the actuating input unit 12, include at least three actuating keys, namely a MENU key 12a, a DOWN key 12b and a DECISION key 12c.

The operations of the electronic apparatus 20, carried out by the actuation of these actuating keys, will be explained subsequently.

The remote controller for in-store support 10 includes a remote controller IC11. This remote controller IC11 is provided with electrical signals which are in keeping with the actuating keys of the actuating input unit 12. The remote controller IC11 generates driving signals, which are in keeping with the input information, as entered by actuations on the various actuating keys, for driving a command light emitting unit 13. This command light emitting unit 13 is actuated by the inputting of the driving signals, and radiates an infrared command signal consistent with each actuating key of the actuating input unit 12.

It is noted that command signals, radiated from the remote controller for in-store support 10, responsive to actuation on the actuating keys, in particular the command signal, which is in keeping with the MENU key 12a, is radiated with an inherent light pattern different from any of the patterns of the command signals radiated from the remote controller 20a annexed to the apparatus.

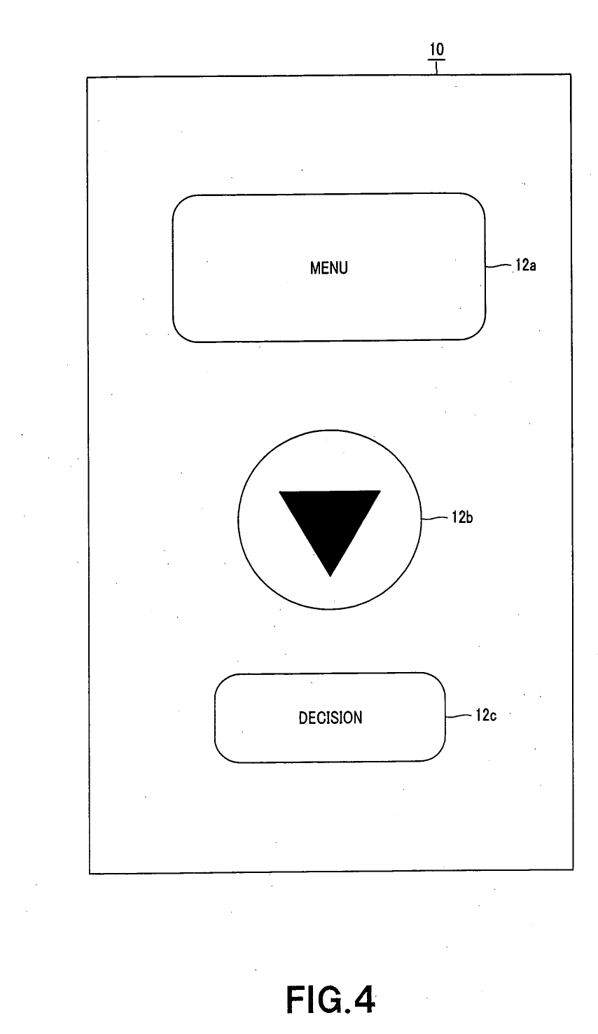

Referring to FIGS. 4 to 6, the sequence of operations for booting the in-store support mode in the in-store support system 1 of the present invention will now be explained.

First, when the in-store support mode for the electronic apparatus 20 is to be booted, the salesman/saleswoman of a store pushes one of buttons of the MENU key 12a of the remote controller for in-store support 10, arranged as shown in FIG. 4.

If any button of the MENU key 12a is pushed, the remote controller for in-store support 10 emits an infrared command signal, in keeping with the button of the MENU key 12a pushed.

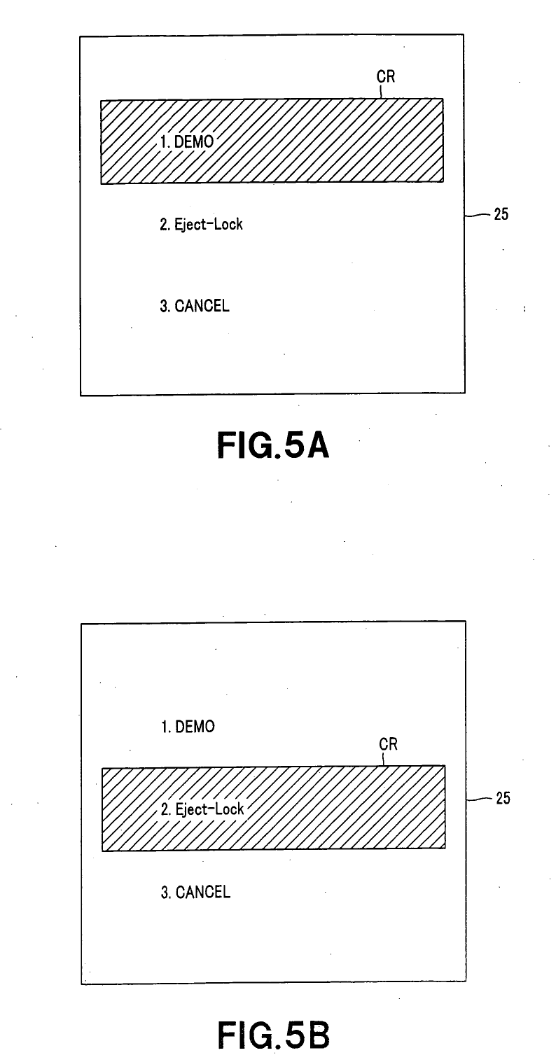

In case the infrared command signal, thus radiated, in keeping with the button of the MENU key 12a, is received by the electronic apparatus 20, the micro-computer 21, shown in FIG. 2, executes the processing of demonstrating an in-store support mode menu image, shown in FIG. 5A, on the display 25.

This in-store support mode menu image demonstrates items of operation the electronic apparatus 20 may execute under the in-store support mode (mode operations) and an item of operation cessation (operation stop) for canceling the operation under the in-store support mode.

That is, in the in-store support mode menu image, there are displayed two items of mode operation that may be run under the in-store support mode, that is, ‘DEMO’ of item 1 and ‘Eject-Lock’ of item 2, as mode operation items that may be run under the in-store support mode. Meanwhile, ‘CANCEL’ of item 3 is the item of mode cessation or mode cancellation.

In this in-store support mode menu image, the operation of ‘DEMO’ of item 1 may be exemplified by the operation of turning the lamps provided on the apparatus on or off, and the operation of demonstrating legends for functional explanation on the display 25, by way of performing the functions of demonstration described above.

The ‘Eject-Lock’, as the item 2, annuls the eject operation. That is, setting is made for disabling the eject operation for the purpose of prohibiting burglary of the recording medium loaded on the medium loading unit 26.

The ‘Cancel’ of item 3 is an item for canceling the operations of the items 1 and 2, as will be explained subsequently.

When the salesman/saleswoman has determined to select a desired operation item from the operation items demonstrated as the in-store support mode menu on the display 25, he/she acts on the DOWN key 12b, provided to the remote controller for in-store support 10, to cause downward movement of a cursor CR shown on the viewing screen, as shown in FIG. 5B.

When the selected item of operation is to be carried out by the electronic apparatus 20, the DECISION key 12c, shown in FIG. 4, is thrust.

Responsive to the actuation of the DECISION key 12c, the electronic apparatus 20 carries out the operation which is in keeping with the item as specified by the cursor CR.

For example, if the item 1 is selected, the micro-computer 21 of the electronic apparatus 20 executes the processing operations of turning the lamps on or off or demonstrating e.g. the text for functional explanation on the display 25. If the item 2 is selected and set, the electronic apparatus changes the setting of annulling the operation for ejection.

If, in this case, both the operations of the items 1 and 2 are to be executed for the electronic apparatus 20, one of the two items is decided on and the other item is decided on and executed by the similar sequence of operations.

If none of the items 1 and 2 has been executed and, notwithstanding, the operation of ‘CANCEL’ of the item 3 has been decided on, it is sufficient that the operation of the DECISION key 12c for the item 3 is annulled.

Meanwhile, the remote controller for in-store support 10 of the present embodiment is provided only with the DOWN key 12b, as a direction indicating key, as shown in FIG. 4. Thus, if, in case the cursor CR is indicating the lowermost item 3 on the screen, during the selection of the operating items on the in-store support mode menu image, the DOWN key 12b is actuated, the cursor CR points to the uppermost item 1.

The sequence of operations in canceling the operation of the in-store support mode, so far carried out by the electronic apparatus 20, will now be explained.

First, when the operation being carried out is to be canceled, the MENU key 12a of the remote controller for in-store support 10 is pushed to demonstrate the in-store support mode menu image on the display 25, as shown in FIG. 5A.

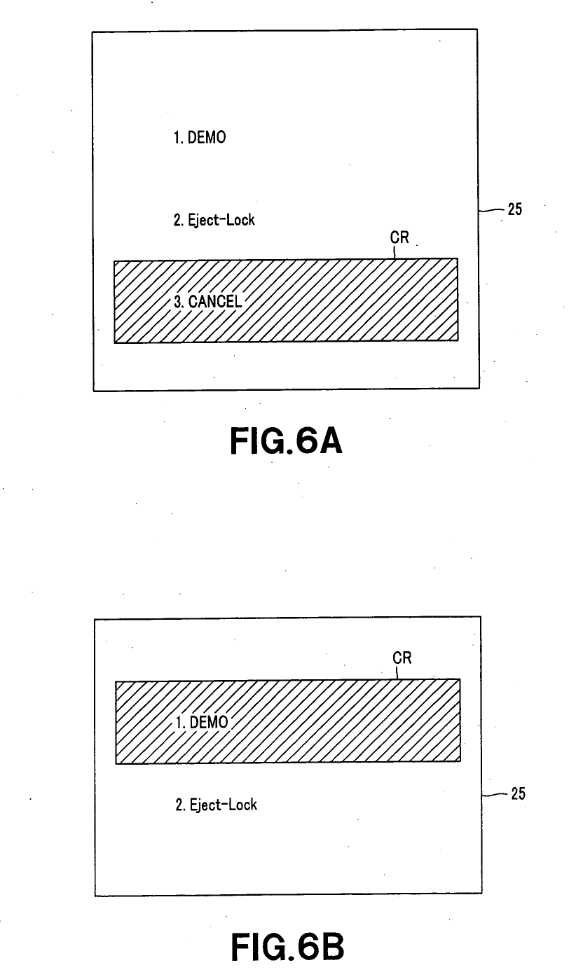

The DOWN key 12b of the remote controller for in-store support 10 then is actuated to set the cursor CR in alignment with ‘CANCEL’ of the item 3, as shown in FIG. 6A. The DECISION key 12c is then actuated to decide on this item ‘CANCEL’.

By selecting and deciding on the item ‘CANCEL’, the two items of operation are demonstrated on the display 25 of the electronic apparatus 20, as shown in FIG. 6B. This demonstration prompts the user to select which of the items for operation is to be canceled.

The salesman/saleswoman then may push the DOWN key 12b to cause movement of the cursor CR to select the item of operation to be canceled.

When the item for operation which is to be canceled has been selected, the DECISION key 12c is thrust to request the electronic apparatus 20 to cancel the item.

The electronic apparatus 20 is responsive to the actuation of the DECISION key 12c to proceed to cancel the operation of the item thus selected and decided on by the micro-computer 21. This terminates the operation of the item selected and decided on to be canceled.

Referring to FIG. 7, the processing operation for executing the operation of the in-store support system 1, according to the present invention, will now be explained.

The processing operation, shown in FIG. 7, is carried out by the micro-computer 21, based on the in-store support mode program 22b, stored in the ROM 22 shown in FIG. 2.

First, in a step S101, it is monitored whether or not the infrared command signal can be received by the remote-controller light receiving unit 23 shown in FIG. 2.

If the command signal from the remote controller 20a annexed to the apparatus or the command signal from the remote controller for in-store support 10, shown in FIG. 1, is received by the remote-controller light receiving unit 23, the processing of a step S102 is carried out.

In this step S102, it is verified whether or not the command signal received in the step S101 is a command signal associated with the remote controller for in-store support 10.

It is noted that the command signal transmitted from the remote controller for in-store support 10 is of a signal pattern different from the command signal transmitted from the remote controller 20a annexed to the apparatus. Consequently, the micro-computer 21 in a step S102 is able to distinguish the two command signals from each other.

If, in the step S102, it is determined that the command signal received is not that emitted from the remote controller for in-store support 10, processing transfers to a step S114 to carry out usual processing in accordance with the command signal radiated from the remote controller 20a annexed to the apparatus.

The electronic apparatus 20 as an AV apparatus executes the functions that may be done by the remote controller 20a annexed to the apparatus.

If, on the other hand, it is determined in the step S102 that the command signal received is that emitted from the remote controller for in-store support 10, processing transfers to a step S103.

In this step S103, it is checked whether or not the command signal received is the command signal which is in keeping with the MENU key 12a provided to the remote controller for in-store support 10. Thus, it is checked whether or not the code pattern of the command signal as received coincides with the relevant pattern held in a table stored in the ROM 22.

If it is determined that the command signal received is not the command which is in keeping with the MENU key 12a, the processing of monitoring the command received in the step S101 is again carried out. That is, since the in-store support mode menu image has not been displayed in this stage, the operations by the keys other than the MENU key 12a, that is, the DOWN key 12b and the DECISION key 12c, is handled as invalid.

If the command signal received in the step S103 is determined to be a command in keeping with the MENU key 12a, processing transfers to a step S104.

In this step S104, the in-store support mode menu image is demonstrated on the display 25.

The in-store support mode menu is made up by the items of operation operable under the in-store support mode, and the item of cessation of operation for canceling the operations of these items of operation, as shown in FIGS. 5A and 5B.

Meanwhile, in the cases of FIGS. 5A, 5B, 6A and 6B, all of these items are displayed on one viewing screen to enable the selection of any of these items. However, if these items cannot be displayed at a time, the displayable items may be displayed sequentially. If only one item can be displayed, item display may be fed one by one at a time, that is, scrolled, responsive to actuation of the DOWN key 12b, for selecting the items.

In the next step S105, processing for selecting the respective items, displayed in this manner as in-store support mode menu image, is carried out.

That is, processing for item selection is carried out, such as by causing movement of the cursor CR responsive to actuation of the DOWN key 12b.

Then, in a step S106, decision is made as to whether or not the command signal relating to the DECISION key 12c has been received.

If it is retained that the command signal relating to the DECISION key 12c has not been received as yet, the processing for item selection of the step S105 is carried out.

If it is retained that the command signal relating to the DECISION key 12c has been received, processing transfers to a step S107.

In this step S107, it is determined whether or not the item, decided on in the above step S106, is ‘CANCEL’ of the item 3 shown in FIG. 5.

If, in this step S107, the item decided on in the step S106 is determined to be ‘CANCEL’, so that the result of check obtained is affirmative, processing transfers to a step S110.

If the item decided on in the step S106 is determined not to be ‘CANCEL’, so that the result of check obtained is negative, processing transfers to a step S108.

In the step S108, the processing for closing the in-store support mode menu image, demonstrated on the display 25, is carried out.

That is, the text, as the in-store support mode menu image, demonstrated on the display 25, ceases to be demonstrated.

In the next step S109, the operation relating to the item for operation, decided on in the above step S106, is carried out.

That is, if the item of operation, decided on in the step S106, is ‘DEMO’ of the item 1, for example, the processing for controlling the main functional body unit 24, shown in FIG. 2, to turn the lamps, provided on the surface of the apparatus, on or off, or for demonstrating e.g. the text for functional explanation on the display 25, is carried out. On the other hand, if the item of operation, decided on, is ‘Eject-Lock’ of the item 2, setting is changed so as to annul the eject operation to inhibit the operation for ejection in the medium loading unit 26 shown in FIG. 2.

In this manner, the operations of the in-store support mode, relating to the item of operation, selected and decided on as being to be executed by a user (i.e. salesman or saleswoman) in the above steps S105 and S106, are carried out.

In this case, it may be an occurrence that the item of an operation being currently executed is selected and decided on in the step S106. In such case, the operation in question is annulled.

For coping with this, the sequence of operations, shown in FIG. 7, is actually carried out by checking whether or not, prior to the processing in the step S108, for example, the item for the operation which is the same as that currently going on was decided on. If the item for the operation decided on is already proceeding, the processing for selecting the item in the above step S105 is carried out to annul the past decision operation.

Alternatively, the operation of the item currently going on is not demonstrated actively on the in-store support mode menu image so that the item being executed may not be selected. In this case, it is checked, before carrying out the processing of the step S104, whether or not there is any item of the operation currently going on and, based on the result of the decision, only the item(s) not carried out as yet is displayed in active state on the in-store support mode menu image.

In a step S110, to which processing transfers in case the affirmative result has been obtained in the step S107, the respective items of the operations are demonstrated on the display 25. In this case, the items of ‘DEMO’ and ‘Eject-Lock’ are displayed, as shown in FIG. 6A, to prompt the user to select the item to be canceled.

In the next step S111, processing for selecting the item to be canceled is carried out. Similarly to the processing of the previous step S105, the processing for item selection in this case is carried out such as by causing movement of the cursor CR responsive to the actuation of the DOWN key 12b.

In a step S112, it is checked whether or not a command signal relating to the DECISION key 12c has been received. If it is determined that the command signal, relating to the DECISION key 12c, has as yet not been received, the processing for selecting the item for cancellation of the above step S111 is carried out.

If it is determined that the command signal relating to the DECISION key 12c has been received, processing transfers to a step S113 to execute the processing for canceling the operation relating to the item decided on in the step S112.

This cancels the operation of the item, selected as being to be canceled, by the user.

There may be occasions where, even in such case, the item ‘CANCEL’ is decided on in the step S106, despite the fact there is no item of the operation then going on.

For coping with this, the processing operation pertinent to the above-described item for cancellation, although not shown, is actually carried out as follows:

As the pre-processing for the processing of displaying the items for operation in the step S110, for example, it is checked whether or not there is any item of the operation currently going on. The processing operation as from the step S110 is carried out only when the results of the decision indicate that there is an item of an operation currently going on. If it is determined that there lacks the item of the operation currently going on, the decision operation for the item ‘CANCEL’ for this case is annulled, as an example, such as by again executing the processing for item selection in the step S105.

In the above case, it is determined by the above-described decision processing that there is the item for the operation currently proceeding to transfer to the processing of selecting the item for cancellation, However, there are occasions where the item for the operation as decided on in the step S112 is currently not going on.

In such case, it is sufficient to annul the decision operation, such as by re-executing the processing for item selection of step S111, in the same way as described above.

Alternatively, for avoiding this inconvenience, only the item for the operation, currently being executed, may be displayed in an activated state, for example, based on the result for decision of the item for operations then proceeding, as verified before the above step S110.

Thus, the in-store support system 1, according to the present invention, is configured so that the electronic apparatus 20 demonstrates the in-store support mode menu image, in response only to the command signal relating to the MENU key 12a of the remote controller for in-store support 10.

In this case, the remote controller for in-store support 10 is to be donated only to an entity performing commercial demonstration, such as a retail shop, as already explained with reference to FIG. 1, whereby it is possible to prevent the in-store support mode menu image from being displayed during usual use by users at large.

It is presupposed in this case that the user is unable to get the operations of the respective items actually executed as the in-store support mode menu image is displayed on the electronic apparatus 20. This prevents the in-store support mode from being booted during use by the users at large to inconvenience the users due to the in-store support mode unnecessarily booted during the normal use or to cause the labor on the part of the user to cancel the so booted in-store support mode.

In addition, as explained with reference to FIGS. 5 to 7, the electronic apparatus 20 according to the present invention is configured for booting and canceling the operations of the in-store support mode based on hierarchical menu display. Thus, with the in-store support system 1, the salesman/saleswoman is able to boot or cancel the operation of a desired item if only he/she causes the in-store support mode menu image to be displayed to then carry out the operations in accordance with the displayed contents.

Thus, with the in-store support system 1, according to the present invention, the salesman/saleswoman does not have to learn special operations, such as were needed with the conventional system, in order to boot the in-store support mode.

If there are provided plural electronic apparatus 20 in the in-store support system 1, according to the present invention, it is readily possible to boot the in-store support mode for the totality of the electronic apparatus 20 with the sole remote controller for in-store support 10.

That is, in the electronic apparatus 20, according to the present invention, in which the in-store support mode menu image is displayed responsive to the commands of the MENU key 12a of the remote controller for in-store support 10, the in-store support mode may be booted by actuations on the sole remote controller for in-store support 10, even though there are provided a plural number of the electronic apparatus 20.

With the electronic apparatus 20, used for the in-store support system 1, according to the present invention, since there are imposed no particular limitations to the functions proper to the main functional body unit 24, as shown in FIG. 2, there are occasions where the plural electronic apparatus 20 are of different models.

Even if the plural electronic apparatus 20 are of different models, in this manner, the operations of desired items may be booted or canceled for the electronic apparatus 20 used in the present invention, if only the menu image is displayed as described above, and if the operations are subsequently carried out in accordance with the display contents. Hence, the in-store support mode for plural electronic apparatus 20 of different models may be booted by operations on the sole remote controller for in-store support 10.

With the conventional system or electronic apparatus, the in-store support mode, such as that described above, is booted by pushing plural actuating keys by multiple pushing. With the plural electronic apparatus of different models, the types of the actuators for these apparatus are of different sorts, such that the operations for booting the in-store support mode differ from one model to another. Hence, the salesman/saleswoman has to learn the operations for booting the in-store support mode by heart from one model to another.

In contrast thereto, with the in-store support system 1 of the present invention, the in-store support mode for the plural electronic apparatus 20 of different models can be booted by actuation of the MENU key 12a and the DECISION key 12c on the sole remote controller for in-store support 10, so that it is unnecessary to learn the operations by heart from one model to another. The result is that the in-store support mode may be booted for plural electronic apparatus 20 of different models by actuating the necessary minimum number of the actuating keys.

Thus, with the in-store support system 1 of the present invention, it is possible to avoid the inconvenience that the in-store support function owned by the electronic apparatus cannot be used efficaciously owing to the unclear booting method.

With the present invention, it is possible to provide, as an in-store support system, such a system including the electronic apparatus having the in-store support mode mounted thereon, in which the serviceability on the part of the retail store can be compromised with that on the part of the user at large.

Moreover, the in-store support system 1 may be implemented by addition of a certain program portion for carrying out the processing operations shown in FIG. 7, and the remote controller for in-store support 10, to the conventional electronic apparatus having the conventional in-store support mode mounted thereon. Since remote controller for in-store support 10 is presupposed to be supplied only to the retail store, as described above, only a relatively small number of the remote controllers for in-store support suffices.

Thus, the in-store support system 1 according to the present invention may be implemented by addition of a simplified inexpensive structure or configuration to the electronic apparatus having the conventional in-store support mode mounted thereon.

The operation of the electronic apparatus 20, used in the in-store support system 1 according to the present invention, may be carried out in accordance with an in-store support mode program 23b stored in a ROM 23 shown in FIG. 2. If this program is recorded on a recording medium to form e.g. a package medium, the program for allowing the operation of the electronic apparatus 20 according to the present invention may be provided more readily. In addition, the in-store support mode program 23b can be installed or upgraded in version more smoothly.

Another embodiment of the in-store support system 1 according to the present invention will now be explained.

With the present modification of the in-store support system 1, the command codes of the remote controller for in-store support 10 are formed in accordance with a special code pattern, in order to prevent the codes of the command signals, transmitted by the remote controller for in-store support 10, for example, from being copied by a so-called remote controller having the learning functions.

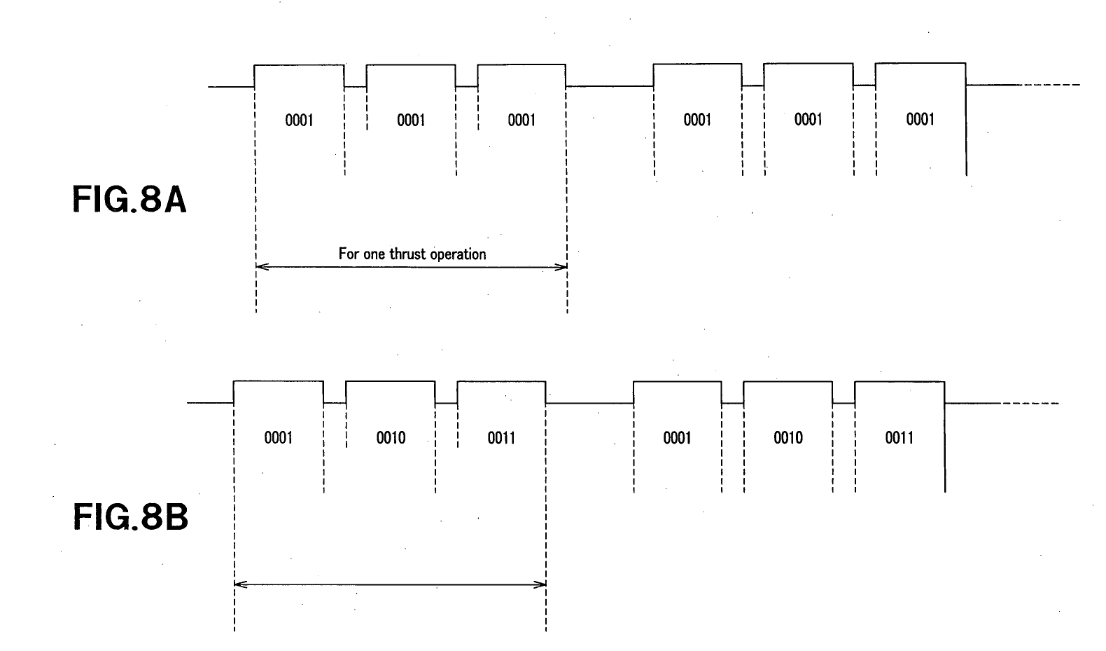

FIGS. 8A and 8B compare the command signals, transmitted by a routine remote controller, to those transmitted by the remote controller for in-store support 10.

In FIG. 8A, the routine remote controller transmits the same code pattern, matched to a particular operation, a number of times on end, in consideration that the commands may not be received as regularly due to, for example, malfunctions in the communication system. It is noted that the portions of the command signals of a routine remote controller, indicated by a double-headed arrow in FIG. 8A, represent one push operation on an actuating key.

Hence, the receiving side, associated with the routine remote controller, discriminates the operations based on the preset same concatenated command codes as described above. Stated differently, the operations cannot be distinguished unless the same command codes are received in succession.

In similar manner, a learning remote controller cannot learn a command unless the same commands are received in succession.

Thus, in the present embodiment, the command signals for one push operation on an actuating key comprise a succession of code strings, each of which is composed of different codes, as shown in FIG. 8B. In this case, a set of unit codes ‘0001’, ‘0010’and ‘0011’ of FIG. 8B is a command code representing one operation. The electronic apparatus 20 is set so as to recognize the pattern of this set of codes as an operation command. This effectively prevents the command signals, transmitted by the remote controller for in-store support 10, from being learned (copied) by the learning remote controller.

By disabling the copying of the remote controller for in-store support 10, in this manner, it is possible to prevent the in-store support mode of the electronic apparatus 20 from being booted in an unauthorized fashion, so that it becomes impossible to cancel e.g. the setting of the ‘Eject-Lock’ as the in-store support mode to illicitly take out the recording medium loaded on the electronic apparatus 20.

In this case, it is sufficient that, in plural unit codes, indicating an operation, at least one unit code differs in pattern from the other unit codes.

In the foregoing explanation, there are plural items for the operation that may be executed under the in-store support mode. However, there may be only one item for the operation.

In the latter case, there is no necessity to select an item for the operation from plural items for the operations by the remote controller for in-store support 10. Hence, it is only sufficient in such case that a sole actuating key for requesting the electronic apparatus 20 to execute this one sort of the operation is provided to the remote controller for in-store support 10. The salesman or saleswoman may then boot the in-store support mode by a sole actuating operation on the sole actuating key provided to the remote controller for in-store support 10.

In the foregoing explanation, an infrared remote controller is used as the remote controller 20a annexed to the electronic apparatus 20 and as the remote controller for in-store support 10. Alternatively, a remote controller of the electrical wave type, for example, may be used.

The remote controller for in-store support 10 is a wireless device for transmitting operation commands for the electronic apparatus 20 by wireless means. Alternatively, the remote controller for in-store support may also be a wired type device.

In addition, the above-described various operations of the in-store support mode are given only by way of example such that the operations of the in-store support mode may be any other suitable operations that may be set for being executed on the occasion of commercial demonstration.

### INDUSTRIAL APPLICABILITY

According to the present invention, described above, the present invention discloses an electronic apparatus system composed of one or more electronic apparatus and an inputting device, in which the electronic apparatus executes control operations for carrying out preset operations relating to the commercial demonstration mode, in response only to a preset command transmitted from the inputting device. Thus, in case there are provided plural electronic apparatus, each of the apparatus boots the commercial demonstration mode responsive to the preset command transmitted from the inputting device. Hence, the operation of booting the mode of commercial demonstration for each of the plural electronic apparatus may be taken care of by the sole inputting device.

Moreover, if the inputting device is supplied to only the entity undertaking the commercial demonstration, such as the retail store, the users at large are unable to use the inputting device. This prevents the in-store support mode from being booted during use by the users at large to inconvenience the users due to unneeded booting of the in-store support mode during use or to cause the labor on the part of the users at large to cancel the so booted in-store support mode.

Consequently, the present invention provides, as an in-store support system, including the electronic apparatus having the in-store support mode mounted thereon, such a system in which the serviceability on the part of the retail store can be compromised with that on the part of the user at large.

1. An electronic apparatus system comprising one or more electrical apparatus and an inputting device;
said inputting device including
operation inputting means having one or more actuators; and
command transmitting means for transmitting, responsive to actuation on said actuator(s) of said operation inputting means, a preset command code for causing said electronic apparatus to perform control operations for executing a preset operation relating to a mode of commercial demonstration;
said electronic apparatus including
receiving means for receiving at least said command code; and
control means for exercising control, responsive to the command code received by said receiving means, for carrying out the preset operation relating to said mode of commercial demonstration.

2. The electronic apparatus system according to claim 1 wherein said control means executes
presentation control for presenting, responsive to a command for item presentation, a plurality of preset items pertaining to said mode of commercial demonstration, by a hierarchical menu;
selection control for allowing selection of an item from the items presented by said presentation control, responsive to said command for item selection; and
mode operation execution control for allowing the execution of a preset mode operation, responsive to a command for deciding on an item selected by said selection control, in case the item decided on indicates a preset mode operation to be executed.

3. The electronic apparatus system according to claim 1 wherein said control means executes
presentation control for presenting, responsive to a command for item presentation, a plurality of preset items pertaining to said mode of commercial demonstration, by a hierarchical menu;
selection control for allowing selection of an item from the items presented by said presentation control, responsive to said command for item selection; and
mode operation halting control for halting the execution of a preset mode operation, responsive to a command for deciding on an item selected by said selection control, in case the item decided on indicates a preset mode operation to be halted.

4. The electronic apparatus system according to claim 1 wherein said preset command code, transmitted by said command transmitting means, is a plurality of concatenated sets, each made up of a plurality of unit codes, each unit code being formed by a preset number of unit bits, at least one of said unit codes not being coincident with the remaining unit code or codes.

5. A method for supporting commercial demonstration in an electronic apparatus system comprising one or more electrical apparatus and an inputting device, wherein
said inputting device is responsive to actuation on one or more actuators of operation inputting means to execute a command transmitting operational sequence for transmitting a preset command code for causing said electronic apparatus to carry out control processing for executing preset operations pertaining to the mode of commercial demonstration; and wherein
said electronic apparatus executes at least a receiving operational sequence of receiving said command code, and a control operational sequence of exercising control responsive to the command code received by said receiving operational sequence to allow execution of said preset operations pertaining to the mode of commercial demonstration.

6. An electronic apparatus in an electronic apparatus system comprising an inputting device and said electronic apparatus, said inputting device including one or more actuators and transmitting a preset command code responsive to actuation on said one or more actuators to cause said electronic apparatus to carry out control processing for executing preset operations pertaining to the mode of commercial demonstration, said electronic apparatus comprising
receiving means for receiving at least said command code; and
control means for exercising control responsive to the command code received by said receiving means to execute preset operations pertaining to said mode of commercial demonstration.
